(19) United States
(12) Patent Application Publication
(10) Pub. No.: US 2022/0101708 A1
(43) Pub. Date: Mar. 31, 2022

(54) Providing A Simulation of Fire Protection Features and Hazards to Aid the Fire Industry

(71) Applicant: Fire Solutions Group, Seven Valleys, PA (US)

(72) Inventor: James Andy Lynch, Seven Valleys, PA (US)

(73) Assignee: Fire Solutions Group, Seven Valleys, PA (US)

(21) Appl. No.: 17/490,360

(22) Filed: Sep. 30, 2021

Related U.S. Application Data
(63) Continuation of application No. PCT/US20/26169, filed on Apr. 1, 2020.
(60) Provisional application No. 62/827,379, filed on Apr. 1, 2019.

(51) Int. Cl. G08B 17/12; G06T 19/00; G06F 3/0488

(52) U.S. Cl. CPC G08B 17/125; G02B 2027/0178; G06F 3/0488; G06T 19/006

(57) ABSTRACT

A system and method of preparing an augmented reality (AR) composite view, configured to create, edit, store, and display fire safety information, hazards, and location information. The system includes an AR editing tool such that a user may edit and input information into an electronically stored database. The system includes an AR viewing tool, where the relevant information from the electronically stored database is determined based on each user's location, and optionally view direction. The AR viewing tool displays a composite image representative of each user's view and incorporating icons representative of useful information, including fire protection features and hazards.

### CROSS-REFERENCE TO RELATED APPLICATIONS

This application is a non-provisional application claiming the benefit of the filing dates under 35 U.S.C. § 119(e) of Provisional Patent Application No. 62/827,379, filed Apr. 1, 2019 and PCT Patent Application No. PCT/US20/26169, filed on Apr. 1, 2020.

### FIELD OF THE INVENTION

The present invention relates to method and system of using hardware and software, along with real time provided information in combination with catalogued information that will provide geospatial information pertaining to fire hazards and fire protection features. More particularly, the invention relates to augmented reality (AR) that will provide pertinent information concerning fire protection features and hazards, as may usefully be provided to building owners and managers, Authorities Having Jurisdiction (AHJs), Fire Protection Engineers (FPEs), insurance agents, and fire department personnel.

### BACKGROUND

Buildings and sites contain a number of fire protection features such as smoke and fire detectors, suppression systems, Fire Department Connections (FDC), and fire extinguishers. In additions, these same building and sites can contain fire hazards, biohazards, deficiencies to the fire protection systems and hazardous materials.

The National Fire Protection Association (“NFPA”) fire codes, and the International Fire Code (“IFC”) (collectively, the “fire code”) are promulgated internationally and widely adopted in international jurisdictions, by the relevant Authorities Having Jurisdiction, and dictates that required fire protection features be properly installed and regularly inspected, tested and maintained. The fire code also dictates that categories of known fire hazards be appropriately marked.

The location and related information on the fire protections features and hazards are important to multiple parties, including but not limited to the building owners and managers, Authorities Having jurisdiction (AHJs), Fire Protection Engineers (FPEs), insurance agents and Fire Department personnel.

It is common for fire protection engineers or fire department personnel to conduct a Fire Hazard Analysis (FHA), emergency pre-plan, and or code review to evaluate the fire protection features and any deficiencies along with the fire hazards.

The information collected is turned over to the appropriate parties, which could include the AHJs, the fire department, and the building owner or manager.

In the event of a fire, the responding fire department personnel must evaluate the event during what is known as a “size up”. The size up takes into consideration the available fire protection features and hazards.

The information pertaining to the fire protection features and hazards can be scattered, difficult to obtain, poorly presented, and or have little if any geographic context. The deficiencies found during size up and FHA may not be clear to the receiving party. Access to the information may be limited due to a lack of physical copies. The location of the fire protection features and fire hazards may not be clearly identified.

What is needed is a system and method that is able to catalog relevant information regarding fire hazards, and fire protection equipment that can be edited and updated readily, so that accurate and timely information may be provided to one or more end users, such as fire protection engineers or fire department personnel or other first responders. The system should be able to provide relevant information regarding fire hazards and fire protection equipment, in a manner that can be quickly understood, preferably including graphic identification of the locations of relevant sites, using augmented reality techniques, wherein the icons and information pertaining to the site, its hazards and equipment can be effectively conveyed to the end user in a reliable and fast manner.

### SUMMARY

Described herein are systems and methods for using augmented reality techniques to allow a user to prepare a catalog of fire hazards, resources, and relevant locations that can be stored and accessed electronically, and displayed for the user on a screen combining real world view and computer generated images and information.

In view of the aforementioned shortcomings, an object of the invention, among others, is to provide an augmented reality system comprising an augmented reality tool editor and an augmented reality tool viewer. The augmented reality tool editor may be configured to allow entry and editing of volume information for access by the augmented reality tool viewer. The augmented reality tool viewer may generate an augmented reality composite image.

The augmented reality tool editor may comprise an editor display device, electronic memory storage, a computer accessible database containing volume information that identifies fire protection features and fire protection hazards stored in memory, and a computational device and editing software, which may provide an editor interface, that is configured to allow selective modifications and entries of volume information.

The augmented reality tool view may comprise a viewer display device, a user interface, a camera, a computing device and viewing software. The viewing software may be configured to electronically access a computer accessible database, and create a composite image for viewing on a display. The composite image displayed may comprise volume information overlaid upon an image.

In one exemplary embodiment of the augmented reality system, the image upon which augmented reality information is overlaid may be one of: perspective view received from a camera, 2D plan view, and an image representative of a location.

In one exemplary embodiment, the augmented reality system may utilize an image as a perspective view received from the camera, and the camera is one of: a body mounted camera, a drone mounted camera, a helmet mounted camera, display capable glasses or goggles, a hand held camera, a tablet camera, and a cell phone camera.

In one exemplary embodiment, the augmented reality system may provide a composite image comprised of an image received from the camera, and the overlaid volume information provides an indication of the nature of the fire protection features and fire protection hazards located nearby.

In an exemplary embodiment, the augmented reality system may be provided with a viewer display that is a touch screen for use with a finger or stylus, and configured to recognize inputs and gestures. Furthermore, the input and gestures may be utilized within the system to allow navigation by the user through the user interface.

In an exemplary embodiment of the augmented reality system, the composite image provides a location icon in a fixed location on the viewer display when the camera is located within a pre-determined range of a volume location.

Furthermore, the augmented reality system may provide a composite image that displays an icon representative of all occurrences of the volume information that fall within the composite image. The icon may graphically represent the nature of the volume to the user.

In an embodiment of the augmented reality system, the icon displayed on the composite image may vary in a property proportional with the distance from the camera. In an exemplary embodiment, the property that is displayed proportionally with the distance from the camera is selected from the group of size, opacity, and combinations thereof.

In an exemplary embodiment, the method of using an augmented reality system is taught, where the augmenter reality system is configured to provide a composite augmented reality image comprising volume information and an image, and the method may comprise the steps of: providing an augmented reality tool editor and an augmented reality tool viewer; providing an electronically accessible database containing volume information identifying fire protection features and fire protection hazards stored in an electronic memory; providing an image representative of a user perspective; determining volume information from the electronically accessible database correspondingly located within the image; overlaying an icon representative of each volume information onto the image to provide a composite augmented reality image; and providing the composite augmented reality image on a user display.

In an exemplary embodiment of the method, the image utilized may be one of: perspective view received from the camera, 2D plan view, and representative of a location. Furthermore, in an embodiment, the method of using the augmented reality system may utilize an image as a perspective view received from the camera, and the camera is one of: a body mounted camera, a drone mounted camera, a helmet mounted camera, display capable glasses or goggles, a hand held camera, a tablet camera, and a cell phone camera.

In an exemplary embodiment, the method may utilize an augmented reality system that may provide a composite image comprised of an image received from the camera, and the overlaid volume information provides an indication of the nature of the fire protection features and fire protection hazards located nearby. Furthermore, the system utilized for the method may provide a user display as a touch screen for use with a finger or stylus and configured to recognize inputs and gestures. Still further, the input and gestures may be configured to allow navigation through the user interface.

In an exemplary embodiment, the method of may utilize an augmented reality system wherein the composite image provides a location icon in a fixed location on the viewer display when the camera is located within a pre-determined range of a volume location. Furthermore, within the use of the augmented reality system, the composite image may display an icon representative of all occurrences of the volume information that fall within the composite image, and optionally, each icon may graphically represent the nature of the volume.

### BRIEF DESCRIPTION OF THE DRAWINGS

Some embodiments of the present invention are illustrated as an example and are not limited by the figures of the accompanying drawings, in which like references may indicate similar elements and in which;

FIG. 1 depicts a representative user perspective composite image;

FIG. 2 depicts a representative user display with the 2D plan view composite image;

FIG. 3 depicts representative user display of the AR tool editor

FIG. 4 depicts exemplary icons from NFPA 170 and 400 that may be utilized by the system;

FIG. 5 depicts a representative user perspective composite image;

FIG. 6 depicts the an exemplary communication relationship between the AR tool editor, AR tool viewer and Data storage server;

FIG. 7 depicts a representative user perspective composite image; and

FIG. 8 depicts a representative menu tree of the AR tool editor.

### DETAILED DESCRIPTION OF THE EMBODIMENT(S)

The terminology used herein is for the purpose of describing particular embodiments only and is not intended to be limited of the invention. As used herein, the term “and/or” includes any and all combination of the one or more of the associated listed items. As used herein, the singular forms “a”, “an”, and “the” are intended to include the plural forms as well as the singular forms, unless the context clearly indicates otherwise. It will be further understood the terms “comprises” and/or “comprising”, when used in this specification, specify the presence of stated features, steps, operations, elements, and/or components, but do not preclude the presence or addition of one or more other features, steps, operations, elements, components, and/or groups thereof

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

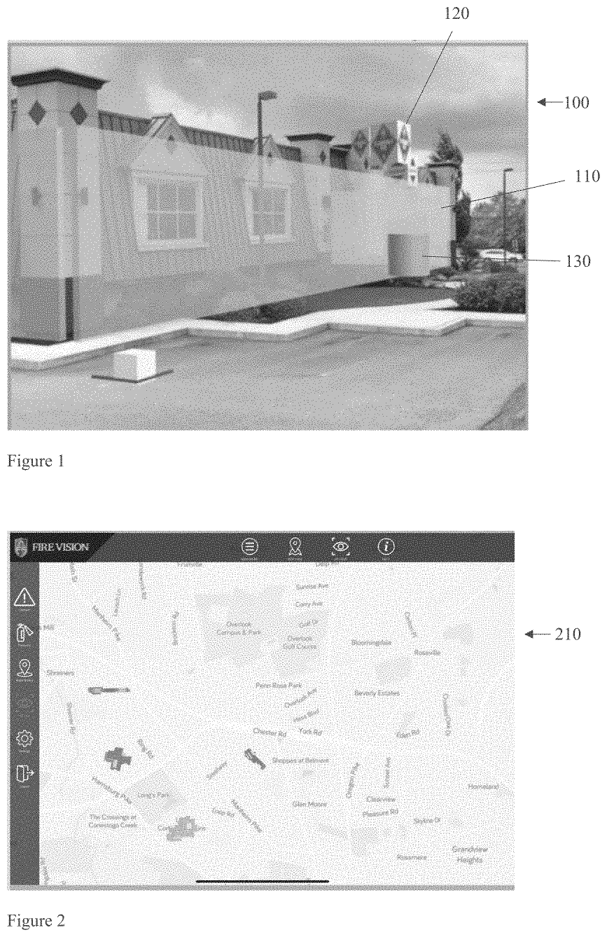

In an embodiment, the invention may provide an Augmented Reality (AR) software editor and viewing tool system, and method of using the system. The system components may include: one or more mobile devices loaded with the AR editor software and capable of rendering the AR image, providing location, communication, and device orientation; one or more mobile devices loaded with the AR viewer software and capable of rendering the AR image, providing location, communication, and device orientation; a wireless communication method, for example cellular communications utilizing a plurality of cellular towers; a location system, such as global position system (GPS), and may utilize one or more of cellular tower or satellite triangulation; and any suitable method and device for data storage, which may be on the device, and/or in the cloud, such as an internet accessible data storage server in the cloud. As employed in the system of the present invention, AR provides a composite view on a display, that combines real world view and computer generated images and information in a single display image, where the computer generated portion of the image is overlaid upon a static or moving real-time image, typically corresponding to a user's view (corresponding to a representative composite image depicted as FIG. 1), though it is also contemplated that an optional 2-dimensional overhead plan view (i.e., satellite view) may be beneficially provided as can be seen in the alternative AR view provided on a user's display (as can be seen with reference to FIG. 2). The computer generated image and information may be partially transparent, so as to not completely obscure the underlying real world image. It is also contemplated, that where appropriate, the computer generated image and information may be created as wire frame depictions, so as to minimize interference with the underlying real world image, yet still convey the necessary location information to the user. For example, the volume demarcation depicted in FIG. 1 may be a wire frame 3 dimensional prism, as an alternative to the partially transparent depiction shown.

It is further contemplated that in an embodiment, either the person perspective view or the plan view, the AR composite image may, as an alternative to a live camera feed, may instead combine a stored image or series of images relevant to the location coordinates, and optionally, the direction of view of the user, and thus corresponding to the actual location, and optionally view of the user, and not necessarily a real time view. In this manner, the AR image may be a representative image of the real time perspective, supplemented with information as provided through the system.

In an embodiment, the AR software editor is part of a system and utilizes software that allows cataloging information, and hardware, including a computing device and a display device. The computing device includes a user interface and a central processing unit. The display device may be, for example, a mobile or fixed touchscreen display, such as a computer tablet or laptop display, a hand held cell phone display, portable media player, or a computer terminal display. The AR software editor is typically accessed via the user interface, for example, a graphical user interface (GUI), that will allow the user to input the GPS location of volumes representing the site, buildings and fire protection features and hazards, and the entries may then be cataloged and stored in memory (remotely or locally on the system) that is accessible by the software. The inputted information may be linked to icons representative of the information attached to each volume. A representative image of a display from the AR editor, depicting the icon selection step is depicted in FIG. 3. While the user may select an appropriate icon to associate with a volume in the displayed view, the user may alternatively select any of the system navigation icons on the periphery of the display, so as to navigate within the software. System navigation icons that may be selected within either the AR viewer or AR editor include icons for “Help”, “Map View”, “AR view”, “Site Info”, and “Main Menu”, as non-limiting examples.

In an embodiment, access and/or editing privileges may be restricted to previously identified, or otherwise authenticated users, relying on verification of authority to add new, delete, or edit the information stored in the system. For example, appropriate users may be designated, and have to satisfy password protection requirements, or otherwise be verified as having editing privileges, using techniques and methods known to those skilled in the art.

The AR viewing tool utilizes a combination of software and hardware, and may display the icons over the volumes entered and stored in memory, superimposed upon the real world view in a composite image presented to the display. The AR viewing tool may be displayed on the same, or alternatively, different display device as may be utilized with the AR software editor. In an embodiment, the AR viewing tool can be utilized by more than one user, simultaneously, each displaying the AR view relevant to each user on a display dedicated to that user. It is also contemplated that a user's screen may selectively be shared with additional users. It is contemplated that AR editing tool or AR viewing tool users may be able to select or request access to view the composite image provided to another user of the AR viewing tool, which may be granted by the user whose display is being shared with others.

In use of an embodiment of the system, each user of the AR viewing tool may be provided with one or more of a display device configured to display a relevant field of view of the user, a computing device capable of running the software and accessing the cataloged entries, and also may optionally include a camera useful for generating an image of the user's view upon which AR elements may be superimposed, as will be discussed. In an embodiment, the display device and the computing device, along with an optional camera, may be combined together, for example, the AR viewing tool and or AR editor tool, may utilize a tablet, smart phone, portable media player, laptop, or an optical head-mounted display. The AR viewing tool will then display those specific entries of the cataloged information the software designates as being relevant, based on the geospatial coordinates relevant to each specific user's view, such that the appropriate information entries can be overlaid over the appropriate real world view, or static substitute image.

In an embodiment, the real world view or image of either or both of the AR viewing tool and the AR editing tool, is provided by a camera associated with the display system, for example, as commonly found on tablet and personal communication devices, for example, mobile phones. It is contemplated that the camera may be functionally separated from the display, and may be associated with the user, such as a body mounted camera, helmet mounted camera, a hand held camera, or an optical head-mounted display or wearable display system (e.g., smart glasses), which may be in electronic communication, such as by being connected via wired or wireless communication connection, for example, through a network connection, to a computing device for processing of the provided image information into the AR composite image which may then be displayed on a display. It is also contemplated that the camera may be a drone mounted camera wirelessly sending image information for processing into the composite AR image. The location and direction of view of each specific user may be determined by using known geolocation techniques known in the art, for example, through the use of radio frequency location, utilizing global positioning systems (GPS) signals, cell tower transmission signal, whereby the location of each user may be determined via triangulation. Furthermore, other known techniques for ensuring accurate geolocation may be employed, including point set registration technology, and may incorporate one or more of: 3d mapping techniques that compare the real world camera view to a prepared 3D map accessible within the system, such that relevant information for that view is contained within the 3D map, and can easily be overlaid upon the real world view; and point cloud mapping, where the real world camera view can be utilized to create a point cloud map of the terrain and features, and can be compared to a 3D model. It is also contemplated that a point cloud map may be created in advance, and using the features from the point cloud map, the real world view could be registered against set points within the point cloud map. By comparing the real world view against a previously prepared map (whether 3D map or point cloud map) the accuracy of the AR composite image can be enhanced. Direction of view of each user, or the relevant camera, may be determined using known techniques, including but not limited to the use of one or more magnetic field sensors, and/or one or more accelerometers, to determine the directionality of the camera view, relative to the direction of gravity and magnetic north. It is also contemplated that the system may be capable of operating without a camera providing a live view. In such an embodiment, for example, the system may detect or otherwise allow for the user to enter a coordinate location, or reference a location on a map (for example, dropping a pin, or location marker, as is commonly known with reference to software mapping programs), and may optionally detect or request an input of a compass heading and elevation heading, or a user-selected direction of view, such that the system may prepare the appropriate AR view utilizing an image previously created, or digitally rendered from the user submitted information, or a prospective view may be prepared, such as may be useful during a size up, virtual visit, or training exercise.

In an embodiment, the system is provided with software that receives and processes the user's geolocation information, along with the imaging information of the user's view, whereupon the computing device will perform the necessary computations to create the composite AR image that can be sent to a display, including a composite image of the user's real world view, supplemented with the relevant catalogued information, which may be in the form of overlaid icons on the image, the icons representing fire protection devices, resources, other users, and/or hazards, merged into the real world image or representative image of each user's perspective. Generally, it is anticipated that the generation of the AR composite image would be similarly prepared, whether within the AR viewing tool or the AR editing tool, and it is primarily in the manner in which data for presentation within the display can be edited or manipulated in the AR editing tool by an authorized user that distinguishes the AR editing tool from the AR viewing tool, as it would not typically allow rights to edit the database, other than to note or flag errors for items entered into the database. In any event, the composite view may optionally be supplemented with additional information, the contents of which may be user selectable, such as displaying date and time, an optional overlay or inset of an alternative view, current compass heading of the user's view, location coordinates of the user, communications, texts or software notifications, or status of personal protection equipment, such as pressure gauge reading for breathing apparatus, as non-limiting examples. Where an alternate view is provided as part of the composite image on the display, it may be an inset window within the real world view image, or alternatively an overlaid image, which may be partially transparent, thus the user could view the alternate view without fully obscuring at least that part of the real world view under the overlaid alternative view. The alternate view may be user-selectable to be any of: the overhead view, typically, where the user's main image is the user's perspective view; or the user's perspective view, typically, where the user's main view is the overhead view. In another embodiment, the alternative view may selectively be another user's view or composite image.

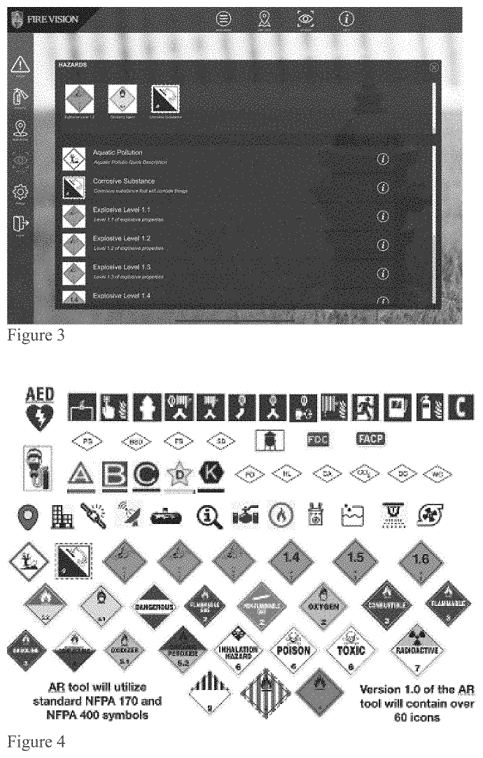

The system may be capable of displaying summary information regarding fire protection features and hazards, and may overlay or otherwise insert standardized icons upon the composite image. The standardized icons to be displayed are to be easily recognizable by the user, so as to indicate the nature of the item represented, and may, for example, be those provided by NFPA Standard for Fire Safety and Emergency Symbols 170 and Hazardous Materials Code 400, representative examples of which are provided with reference to FIG. 4. The NFPA has promulgated icons that are standard symbols used to communicate fire safety, emergency, and associated hazards information. Using easily understood uniform symbols on labels and signs provides consistency, eliminates confusion, and improves communication. The system will graphically convey information and location of hazards and safety equipment, whose meanings are understood by those familiar with the relevant field. Each of the icons relevant to sites within the database may be displayed in the AR composite image, and within the composite image may user-selectable, as will be discussed below.

For the display of the icons within the system, it is contemplated that each entry within the database would have associated one or more icons that is associated with a geographic location, and further be provided with a volume entry that is saved within the database. The system would utilize the location information of the volume, and along with location information for the user, will create a composite image that allows the user to scan a field of view visible through though the display screen, and have the system software create a composite AR image with overlaid icons. The intention is to provide facility owners and managers, authorities having jurisdiction (AHJ), fire protection engineers (FPEs), insurance agents, and fire department personnel with an easy to use AR tool. The AR tool would identify fire protection features, fire hazards, indicating the location and nature of the feature, and other relevant site information.

In an embodiment of the system according to the invention, there is provided software that is designed to accept information, such as may be entered by an editor user, or accessed from an outside database, whereupon the software will catalog the information for storage in memory accessible by the software and the computing device, for example, in a system database, whereby specific elements of the information can be selectively displayed in a location-based augmented reality system, useful, for example, for the fire industry. Such a database may be stored remotely in a data storage server, and the database may consist of a record for each entry, and may provide a unique record identification number; information regarding the item title, class or type; a text description of the item; and may include any other further information such as the date issued or entered into the database, whether the item is active or inactive, and any notes or reminders to re-assess the information, such as through Inspection, Testing, and Maintenance (ITM), as non-limiting examples. It is also contemplated that the database would allow for the entry of attachments, such as PDF, word, or image documents associated with an entry in the database, such that relevant documentary information may be easily accessed through the system. The nature of the information that is to be stored in the database may vary based on the nature of the subject item, and would be well understood by those skilled in the art. In the following description, for the purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description provided.

The present invention will now be described by referencing the appended figures representing exemplary embodiments.

In an embodiment, the AR Editing tool allows an editor using the software to edit the catalogued information, which may be stored in computer accessible memory, in any suitable form. The memory storage may be achieved through the use of a storage device having computer components and recording media used to retain digital data, such that information stored therein is electronically accessible. The information stored in memory may be selectively edited or otherwise modified by an editor user, utilizing software that is able to access the catalogued information, whereupon the user may make the desired edits, including adding or updating information concerning specific sites, and details concerning fire protection features, fire protection hazards and any other useful site information; or alternatively removing outdated or incorrect information.

It is contemplated that, in an embodiment of the AR editing tool, there may be multiple users that would have editing privileges, and needing to access the catalogued information. In such an instance, the system may employ strategies to prevent incompatibilities in the information that can arise from having more than one editor from making changes at a time. For example, the system may lock out additional editors from making changes when another editor is already accessing and editing the catalogued information, in a manner as is known where the user is to digitally check out the document for edits, and the software is configured to prevent others from editing until the document is checked back in as available. Alternatively, the system may utilize known collaborative editing solutions to prevent conflicting edits from being made simultaneously by multiple editing users, such as locking a specific category of information, such as site-specific information, when a first user is editing the specific category or site information. In this manner, a second user is prevented from editing the same category or site simultaneously, to avoid conflicting entries, though the second user would not be prevented from editing a different category or site simultaneously. In any of the embodiments, it is contemplated that the system may track edits by user, by the modification made, the date and time stamp of the modification, and which hardware was utilized in making the edit. In this manner, the system could ensure that edits are capable of being reviewed as part of a quality control confirmation and improper or unnecessary edits may be selectively removed, if so desired or necessary.

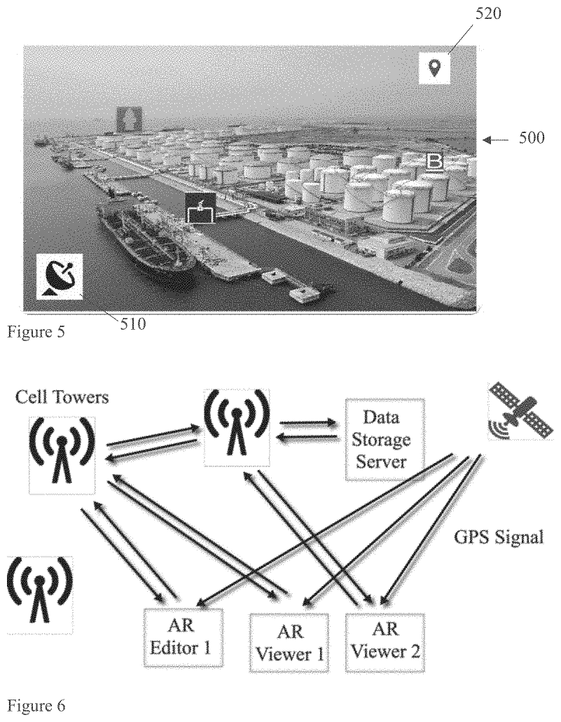

With reference to the figures herein, various aspects of the AR system, with particular emphasis on the viewing tool, and the method of use of the AR viewing tool will be described.

Where the AR editing tool must ensure integrity of the records within the database, whether by allowing only a single editor at any given time, or ensuring that multiple concurrent users do not create conflicting entries by editing the same volume information, the AR viewing tool, by contrast, may readily accommodate one or more concurrent users, as the viewers are not revising the entries within the database, and are only displaying relevant records. In an exemplary embodiment, it is contemplated that each of the AR viewing tool users may utilize information specific to each user's location and view, as made known to a computing device, whereupon the computing device may overlay at least a portion of the relevant information onto an image representative of the specific user's view and/or location, and presented on each user's display as an AR composite view. In an embodiment, the portion of the catalogued information relevant to each user may be presented as an icon indicative of some aspect of the information, and overlaid onto a real world image to make a composite view. For example, where the catalogued information is such that the volume location of a relevant feature, as a non-limiting example, a fire hydrant, would be nearby or within the view of the user, that user's display may depict an overlay of an icon image readily identifiable as the relevant feature, in this instance, depicted as a hydrant, inserted or overlaid into the composite image display (as can be seen, for example, in the composite AR image depicted in FIG. 5) to identify or mark the location of the volume, and correspondingly the associated real world element. In such an instance, the user would be able to tell the approximate direction and location of the specific fire hazard, or fire protection device, relative to the surrounding features and buildings around the user. Additionally, as the icons are overlaid onto a view representing the view of the user, by adjusting the direction of view (or direction of the camera providing the view to the system), the user may readily scan the area surrounding that user, and identify relevant features, as the computing system overlays relevant icons onto the display for the user. In an embodiment, the composite image may provide, associated with one or more icons, additional relevant information. For example, the composite image may display digits indicative of the distance from the user's location, to the location of the object associated with the icon; alternatively, as will be discussed, the user may select the icon to receive further information about the object or volume. It is further contemplated that the AR composite image may provide directional guidance to the user for locating an object or volume associated with an icon. In such an instance, the display may include directional markers, such as finder points or directional paths that may demonstrate a path to the desired location for the user. The directional markers may be spaced apart, and be in the form of one or more waypoints that the user may be instructed pass through or by on the way to the desired location; or in another exemplary embodiment, the AR composite view may provide a highlighted path for the user to follow. The highlighted path and objects on the display may be updated as the user progresses towards the location, in a manner similar to as can be found on vehicle navigation systems.

In some embodiments, the software maybe loaded onto computers, cell phones, tablets, and/or other mobile devices, such that the software is configured to communicate with a display, so as to present the composite image information to the user of the AR viewing tool. The device for providing the display rendered by the software may also be a form of wearable technology capable of providing a display for the wearer, and preferably allow the wearer to see through the display. In an embodiment, the wearable technology may be an optical-head mounted display, including headsets, goggles, or glasses, such as the previously sold Google Glass. It is contemplated that the wearable technology, for example, augmented reality glasses, may provide the required composite image, and may optionally incorporate a camera for generating the composite image, though the camera may be remote from the wearable technology, such as a user mounted camera, for example a body cam, helmet cam, an action cam (e.g., GoPro™ and the like), and the like for providing an image. For example, where the software is loaded on a mobile device having a display, the software may utilize information about the user's location and view coordinates, which may then be sent to a computational device having access to the catalogued information, whereupon the computational device may select the relevant database information as determined by the software to be applicable to the location and view coordinates of the user, selected by the user, or not otherwise to be excluded by optional filters set up in the system. The computational device may be located remotely from the user, or may be contained within the user's mobile device.

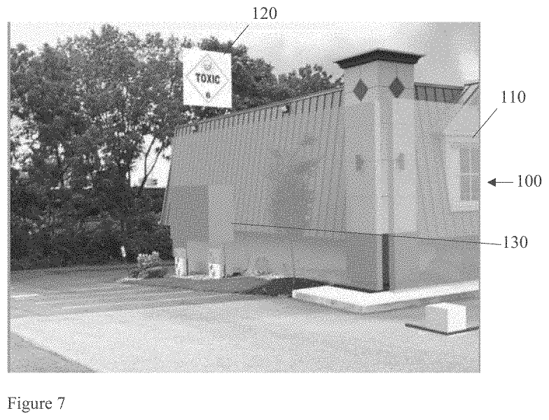

With reference to FIG. 6, one embodiment of the system will be described. The computational device of each of the AR Editor or the AR Viewer may include at least a user interface, a memory device, and a processor, and be capable of electronic communication. It is contemplated that the computational device may be a portable tablet computer or mobile device having a touch screen display, through which the user interface is accessed. In the depicted embodiment, the computational device of one or both of the AR Editor and AR Viewer may access data stored in a data storage server, which may be accessible electronically, for example, via the internet and in the cloud, as is known to those skilled in the art. Electronic communication between the computational devices of the AR Editor or AR viewer and the data storage server may be facilitated through any suitable form of electronic communication, for example, wireless communications, and as depicted in FIG. 1b, may be provided through one or more cellular towers. Generally, there will be a need for the computational devices of either the AR editor or AR viewer to locate and orient themselves, which may be accomplished using one or more of GPS systems, cellular towers, and on board sensing devices (e.g., accelerometer, compass) to locate and provide orientation information for the devices. It is also contemplated that location and orientation information may be supplemented by the system, utilizing image information provided by the camera for the user, from which the software to identify landmarks, or the user may interact with the software, in order to identify landmarks or features within the view to positively confirm locations for the device, or placement of icons on the display. It is contemplated that landmarks or features may be recognized by artificial intelligence, or may rely on user confirmation to identify features that will provide confirmation of location for the system.

The touch screen display may use a finger or stylus, or other gestures to navigate the general user interface. However, one skilled in the art should appreciate that other implements could be used for control and inputting of information, including a computer mouse, keyboard or joystick. In fact, one skilled in the art should appreciate that the computing device is a physical computer, and could be, but not limited to, a desktop computer, a laptop computer, or a cell phone.

The computational device may have an audio input and audio output device, so as to facilitate communication with other users or editors, or other first responders, or authorities having jurisdiction, for example. The computational device may also provide audio feedback, or allow audio input of information, and may incorporate speech recognition technology, such that the interface may optionally be operated using audio commands.

The memory device may be a storage device having computer components and recording media used to retain digital data. The memory device may be remotely accessed, such as through a data storage server, or remote computer, or may even be stored locally in one or more users' computational device. In an embodiment, the computational device may be the tablet or smart phone, and is to be carried by the user, and may have a copy of the database, which may be complete or partially complete of the information, locally stored in the memory accessible by the computational device. The database may be updated wirelessly, or the computational device may be placed into a network connection with another computer or server, whereupon any updates to the database information may be received through the network connection, whether wireless or wired) whereupon the most up-to-date information may be reflected in the locally stored copy of the information. Alternatively, the computational device may wirelessly access a remotely stored database, which may itself be periodically updated to include the most up-to-date information, reflective of any edits made by the editing user(s). It is contemplated that updates to the database, if they interfere with the use of the AR viewing tool, or AR editing tool, may be inopportune when the user is actively employing the system during an emergency situation. To avoid the possibility of an update impeding with a user's access to the system, it is contemplated that when there is an update pending, the system may trigger a notice to the user, such as an email, text notice, or provide a visible icon on the display, at a time and/or at a location on the display where the icon would not interfere with normal use of the device. In such an instance, the user may select when or opt to activate the update at a time and place that is convenient for that user, so as to ensure that there are no detrimental effects from performing the update at an inopportune time.

The processor may be a central processing unit (CPU) that manipulates data stored in the memory device by performing computations, and is configured to generate the composite AR image, using the input information received from the user (location and view coordinates) along with a real world image provided, such as may be provided by a user's imaging device, for example a camera associated with the user's computer, tablet, phone or mobile device; whereupon the processor processes the information received from the database that is relevant to the user's viewpoint, to create the overlay of the digitally stored or accessed information upon the real world image, whereupon the composite image may then be sent to the user's display.

In use of the AR editor, a user may view the AR composite image on the display, and interact with the software via the user interface, which may be through any suitable input mechanism, such as entering inputs through gestures and entries made to touchscreens of the display. A user may make edits to record or modify an entry within the database, by initially selecting an edit icon, which, if the user is onsite, or nearby to the site of the location of the entry to be edited, the software will display a selectable edit icon visible to the user, which may be be located on the home screen of each icons informational window. The edit function may also be used while the user is remotely located. In either event, the user may select to edit one or more of the entries in the database. When the web based edit function is selected, the user may be provided a list of options, such as being prompted to select: “Saved sites”; “Search for a site”; “Saved icons”; “Search for an icon”; “Add new site”; and “Add Hazard or Fire Feature”.

If “add new site” is selected, the user is asked “Current Location” or “Enter GPS”. “Enter GPS” allows the user to enter geolocation volume encompassing the total site using GPS coordinates and a volume base and height. An example of this is shown in Table 1 which contains representative site information of York College. The York College Volume will encompass the land area defined within the base dimensions, as well as 100 ft from ground up. It is contemplated that the defined volume for a site may be a regular shape (e.g., a parallelogram) or alternatively may be an irregular shape, by adding multiple points (any number of points 3 or over).

TABLE 1
Site volume identification of York College.

| | | | Base | Height |
|---|---|---|---|---|
| Latitude | Longitude | Address | (Ft) | (ft) |
| 39.946681 | −76.720813 | S. George St & Country Club | 0 | 100 |
| | | Road | | |
| 39.941638 | −76.738715 | Country Club Road & S. | 0 | 100 |
| | | Richland Ave | | |
| 39.945438 | −76.741809 | S Richland Ave & Kings Mill | 0 | 100 |
| | | Road | | |
| 39.952989 | −76.732303 | Kings Mill Road & Jessup | 0 | 100 |
| | | Place | | |
| 39.948650 | −76.729884 | Jessup Place & W | 0 | 100 |
| | | Springettsbury Ave | | |
| 39.950476 | −76.722352 | W. Springettsbury Ave & S | 0 | 100 |
| | | George St. | | |

Within the AR Editor, the user may select “Current Location” whereupon the software may provide visible on the displayed image a shape, such as a cylinder or a prism, which the user may then manipulate through the interface in order to adjust the dimensions and location of the cylinder to encompass the site for which the volume is being defined. In an embodiment, the adjustment of the size of the volume may rely on using +/− buttons to modify the length, width, and height of the volume defined, alternatively, the user may use drag and drop of the outlined edges of the prism through the touch screen interface. As the AR composite image displays the prism overlaid over the camera view, the user can guide the prism to visibly encompass the site within the volume of the prism, which may then preserve the boundary information, and create the volume to be saved for the relevant entry. After the site volume is defined and anchored to a GPS point the user may be prompted to provide additional site information requested by the software, as will be discussed.

As can be seen with reference to FIGS. 1 and 7, the composite AR image 100 may depict a software created boundary wall 110 that depicts the perimeter of a defined volume for an entry. The boundary wall may be depicted transparently overlaid the feature in the composite image 100 that is being demarcated. Furthermore, within the composite image 100, there may be one or more icons 120 identifying the nature of the hazard represented by the prism 130. As can be seen, the prism 130 is of a defined volume. Furthermore, the boundary wall, though only partially depicted within the composite image 100, would define a volume as well, having a base dimension, and having a height dimension. The creation of the volumes in the AR Editor may be prepared in the overhead plan view, as depicted in FIG. 2, where the map view allows the user to define a boundary by selecting readily identifiable features on the map 210 for defining a volume. For example, as described above, the boundaries of a volume may be based on multiple road intersections, or defined coordinates, which may then form the base dimension of the volume, and have a height dimension assigned by text entry, or alternatively, by switching view to the perspective view for entry of the height dimension of a volume.

### Adding Features

Within the database in the data storage server, the AR editor user may add a hazard or fire protection feature (icon) within a site volume or created as a stand-alone entity (without being associated within a defined volume). It is contemplated that for those entries defined within a volume of a site, the entries may be included in a site report providing details for that volume. Adding volumes can be done by using the current location of the device and selecting “Add Hazard or Add Resourse”. The user will then select either “Current Location” or “Enter GPS”. Once the volume was created the user will be asked to select and icon or icons to associate with the volumes. Additionally, the user may add any information they desire to the icon. The “Current Location” method allows the user to create a record of a hazard or entry in the database quickly, that can be distributed to other users, in a fashion similar to the mapping application Waze, where users can select a road hazard and the hazard is fixed to the user location and warns other drivers of the hazard.

Within the AR Editor software, if the user selects “Add Hazard or Fire Feature,” the user will then be asked for the GPS coordinates. In a manner similar to the creation of volumes, if the selection is made by the user to “Enter GPS” coordinates, the entry of 3 or more GPS coordinates allows the user to create volumes that may be of regular (e.g. prismatic) or irregular (non-prismatic) shapes.

Once the volume for that entry is established, the user may be prompted to associate the entry with one or more relevant icons. The icons as described may be those defined by NFPA 170 and 400, representative examples can be seen with reference to FIG. 4. The user may be presented with a list, whereby the user may scroll through the icons, selecting those that apply. It is contemplated that in selecting the relevant icons, rather than scroll through the list of icons, the user may instead type a full or partial name of each icon in a search box, where the software will provide a listing of possible icons to select from that correspond to the entered text information; or alternatively, the user may select filters that may be applied over the listing, thereby narrowing the selections available based on the filter results, in order to allow efficient icon selection. For each icon selected by the user to associate with an entry, the software may present a window or text box on the display, in which the user may enter information that may be associated with each icon for that entry in the database.

When completed the information is saved to the database on the data storage server, the revised information may then be made available to the linked AR viewers. Within the AR editor, further revisions to each site can be made by the editing user selecting the edit button, and searching for, or selecting the pre-existing site from the menu, using a similar process as has just been described.

In an embodiment, it is contemplated that standalone volumes, that is, those volumes not associated with a site may be searched by name or location.

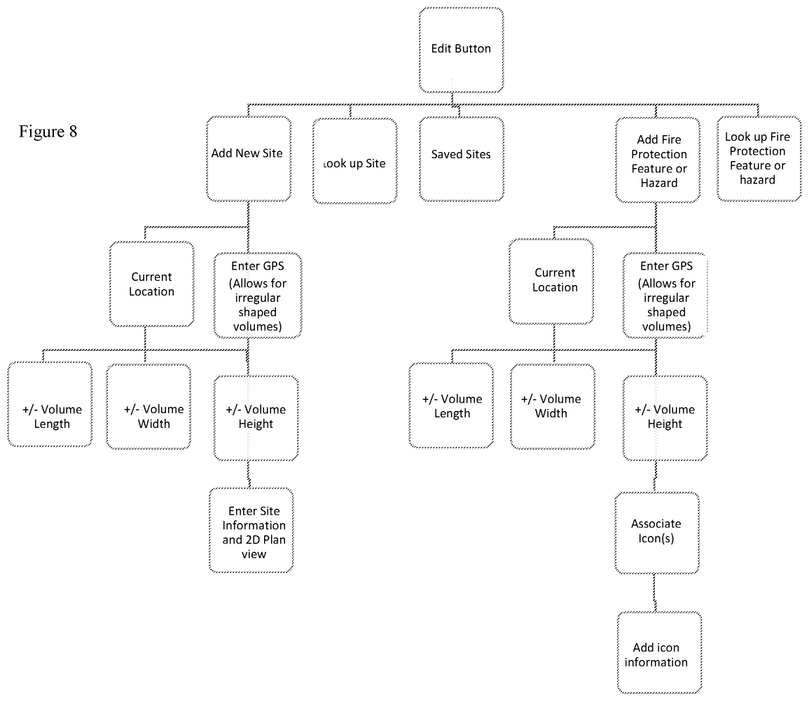

A representative menu tree for navigating the entry of volumes into the database can be seen with reference to FIG. 8.

### Informational Inputs

Within the AR Editor, the user may select informational icons to associate with the entries in the database. Furthermore, each icon may have additional information that may be displayed when an icon is selected. For example, for each icon, there may be any or all of, at least a name, location and description text box. When a user selects the icon, the software will display the information box, which may be of any suitable size to display the text, but be no greater than the screen size, and may have scrolling function to display lengthy text information, and further may be provided with a close button to allow the window to be selectively closed. Where an icon does not have information to be displayed, for example, where an editor has not filled in the information, in such an instance the information window may not appear on a viewer, thereby serving to reduce clutter. For example if the site address is not filled in by an editor, the informational placeholder title “street address”, “city”, “state”, and “zip code” would not appear in the viewer site information.

The software may also be capable providing a reminder for those icons that require Inspection, Testing, and Maintenance (ITM) periodically. The software will allow for the creation of a reminder associated with each icon that will allow the user to specify a date and reoccurring time frame to trigger a reminder message. For example, the software may periodically generate a message via email of necessary ITM. For example, the user may specify a date of Jul. 27, 2019 and then specify weekly interval for ITM. The software would then be capable of alerting the user on the required periodic interval, such as reminding the user on a weekly basis starting on Jul. 27, 2019. The time frames for periodic ITM reminders may be any of daily, weekly, monthly, quarterly, semi-annually, and annually. In an embodiment, a text box will be available for a short message describing the reminder and then generate a message, such as an email, where the reminder will be sent to the specified user. Additionally, for a selected volume, time period, or geographic locale, it is contemplated that the system may generate a report that may be useful for determining any inspection, testing or maintenance that may be required within the given parameters. Such a report may be generated periodically by the system, or upon initiation by a user.

In use of the AR Viewer, a user may view the AR composite image on the display, and interact with the software via the user interface, which may be through any suitable input mechanism, such as entering inputs through gestures and entries made to touchscreens of the display. In some embodiments, if the user is near, or within a given radius of a preconfigured site (e.g., within a geolocation fence of a preconfigured site) the existence of information of that site would be indicated in the display of the user. For example, the icon indicative of the location point may be selectively fixed, and, for example, may be located in the top right of the display screen, as depicted in FIG. 5. Selecting this fixed location point icon will cause the software to overlay information relevant to that preconfigured site on the image.

In some embodiments, upon opening the viewer, the software may identify one or more nearby sites with a location point icon that indicates the location of the site on the display. For example, as can be seen with reference to the exemplary display of FIG. 3, located most remotely away from the user's perspective, the software indicates on the display the presence of a fire hydrant at or near the location as indicated by the overlaid hydrant icon; while relatively closer to the user, the software indicates on the display the presence of a shut-off valve, at or near the location indicated by the valve icon In use of the system, were the user to select one or more of the icons from the display, the software would provide the general information for that site associated with that selected icon. As the user would change his field of view (e.g., by panning the camera to look in a different direction, the location point icons for nearby sites would correspondingly move with the depiction of the physical locations of the items, displayed on the composite image presented by the software.

In an embodiment of the composite AR image, the one or more icons may be depicted as located on the display centered above the physical location the icon is to mark, rather than directly overlaid upon the volume, so as to minimize the potential of the displayed icon interfering with the user's view of the marked object on the screen, as can be seen with reference to FIG. 7. In another embodiment, the icon would be displayed as overlying the volume on the screen.

In some embodiments, the AR composite view sent to the user's display may provide a satellite icon, that may be in any suitable location on the display, and in FIG. 5, is depicted fixed to the bottom left of the AR composite view 500 of FIG. 5. It is contemplated that either, or both of the satellite icon 510 initially in the bottom left, or the location icon 520, initially shown at the top right, as can be seen with reference to FIG. 5, may instead appear on the display in alternate locations, or in a location that is user selectable, rather than being limited to the depicted locations shown in FIG. 5.

The icon 510, upon being selected by the user, will cause the display to toggle between the previously described AR view according to the user's perspective, and a 2D plan view image of the site (see for example, FIG. 2) that may be overlaid with relevant information. The image associated with the icon 510 may shift, depending upon the screen type currently being displayed, such that while in the user's perspective mode the icon 510 may be the satellite icon, and in the 2D plan view, the icon 510 may be a graphic representation of the user perspective view. The 2D plan view may be any suitable overhead representation or view, including a previously generated map or static image (e.g. aerial or satellite imagery), or even an overhead live video feed, which the software may augment with relevant information. The plan view would be similar to mapping functions known in the art, where the user's location may be identified on the map, and relevant icons overlaid upon the 2D plan view image to represent relevant volume information in the vicinity of the user, or selected points. The scale of the displayed image may be user selectable, either by inputting a scale, sliding or swiping a scale, using buttons or selectable icons for +/−, or using a gesture, as may be known in the art to vary the scale selection. For example, the scale of the display may be user adjustable by pinching or expanding two fingers placed against the touch screen. Additionally, the map center location may be moved by dragging with a stylus or finger to relocate the center of the map, or alternatively selecting a new point for the processor to prepare a composite image centered on the selected point.

In an embodiment, other geolocated information icons would appear based on the field of view of the device. For example, where there are relevant volume sites located outside of the user's field of view on the display, but located within a defined range of the user, the location icon for such a volume may be displayed on the image margin, pinned to the margin at approximately a location corresponding along an imaginary line extending from the center of the current field of view to the relative location of the volume. In this instance, as the field of view is shifted towards the pinned icon, and as the field of view is altered to include the location of that volume, the relevant icon would shift from being pinned in the display margin, to tracking with the physical location of the volume within the field of view as it is shifted. Continued shifting of the field of view, may cause the icon to again pin to the margin of the display as the actual volume location leaves the field of view on the display. In this manner, the user may be made aware of nearby locations that are identified by the software, even if those locations are not included within the current display field of view. The location icon being pinned to the margin or exterior perimeter of the display would then serve to identify the direction the user needs to shift his view, as indicated by the placement of the icon on the display margin, so that that user may bring the location icon into the field of view on the display.

In any of the embodiments described herein, each informational icon, whether within the field of view, or pinned to the margin, could be selected by the user, whereupon the display may be altered in response to the selection of the icon to provide additional information and details on the feature or hazard. The nature of the more detailed information could be dependent upon the nature of the volume selected.

In some embodiments, in the event that a given volume or site entry would appropriately be associated with more than one icon, it is contemplated that each of the appropriate icons may be tiled adjacent to each other in a grouping, for example in a grid pattern, that is placed above or superimposed upon the specific volume for which the icons are being depicted. In this manner, the specific icon may still be selected by the user so as to display the desired icon information, but the display may still convey to the user that additional icons (representing hazards or resources) are also relevant to that volume. In such an instance, the dimensions of each icon may optionally be adjusted, either by the software or by the user, so as to avoid overcrowding of the display.

In some embodiments, the software may modify the appearance of displayed icons in order to provide depth of field, for example, in an embodiment, the icon size and transparency will adjust based on distance. In such an instance, it is contemplated that icons that are further away from the user (for example, the hydrant depicted in FIG. 3) would be proportionally smaller, and/or have decreasing opacity to the icon, when contrasted to an icon that is relatively closer to the user's locations, for example the shut-off valve icon (depicted in FIG. 5). In some embodiments, the icons may be classified by color, so as to convey information relating the grouping the icon represents, for example, icons that are representative of fire hazards may be colored in red, icons representative of toxic components may be colored in yellow, and safety equipment may be colored in black. These color assignments are exemplary only, and it is contemplated that other colors, if any, may be associated with other classification of information. The software may allow the user to independently assign colors and characteristics to the icons as user preferences.

In an embodiment, the software may allow the user to apply filters to adjust the displayed information or select a group of icons to be displayed. For example, the user may select to have displayed only icons that are within a desired distance selectable by the user, and/or display icons that are a particular class of icon or location of icon (e.g., fire hazards, resources or fire protection equipment, name, or floor or elevation, etc.) as appropriate for the user's needs.

In some embodiments, the display may provide an icon, such as a settings button, that when selected, the software will display a preferences menu, providing a selection of user selectable options, allowing the user to customize aspects of the display and user preferences that will be reflected in the composite view displayed by the system. For example, the options that are user selectable may include a range selection, a filter selection, a default composite view selection, an offline mode selection. The range selection may allow the user to specify the range from the user's location for displaying icons, for example, the user selectable ranges may be 20 miles, 10 miles, 5 miles, 2 miles, 1 mile, 0.5 mile, 0.3 miles, 0.1 miles, 0.05 miles. The filter selection may allow the user to exclude classes or types of information from the display; for example, the user may select to hide fire protection equipment, so as to allow the user to focus on the fire hazard icons. Alternatively, the user may elect to have the software filter out of the display icons representing fire hazards, and allowing the user to focus on icons representative of toxic material locations. The user may be able to select a default display which the display will provide when used in following sessions, the default display may include options including range, filter option selection, and an option to select between user perspective and aerial view as the default view, for example. The offline mode will, when selected, allow the user to input a location, and provide information from the database downloaded to the user's device, rather than communicate with a remote location to access the remote files, which may update more frequently than the information on the user's device. The above options are exemplary in nature, and it is contemplated that one skilled in the art may easily provide alternative selections than those listed.

In some embodiments of the AR viewing tool, there may be an edit button would be located on the display, such as in the bottom right corner. Selection of the edit button would toggle the system to enter an edit mode within the AR edit tool. In the edit mode, a user having appropriate editing privileges may then update, modify, add or delete information from the database. The edits made may then be reflected in the information displayed to all users of the AR viewing tool.

Aspects and use of the AR edit tool of the system will be described. In some embodiments of the system, a user may utilize the edit function to update the information in real time, or may make edits to the database information that is updated as a batch. It is contemplated that the user edits may be made regardless of the user's location, for example, where the user is on site assessing the site's fire protection features, hazards, or resources, for example; or alternatively, the user may be remotely located and making edits to the information away from the site being assessed, relying on notes, or images taken of the location.

In some embodiments of the system, when the edit button is selected by the user, the software would be prompted to provide a list of options for the user to select, including “saved” sites, “search” feature, or “add new site” option on the user interface or display. If “add new site” is selected, the user is to be asked to enter the site geolocation volume encompassing the total site. Selection of “saved” sites would allow the editing user to browse the entries of sites within the database. Selection of “search” feature would allow the user to enter a search keyword or additional limitations, such as class of entry or location reference for entries within the database.

In some embodiments, once the site volume is defined, the general information for the site would be entered and tied to the site volume within the database of the system. The user could then select the various information icons from a drop down menu, to add further classification information to the volume, within the database.

In some embodiments, when an information icon is selected, the editing user would define a volume or select a pre-defined volume within the bounds of the site volume or the site volume itself (for general information) and enter the relevant information to be displayed.

In some embodiments, the information entered by the editing user into the database may then be saved, and the revised contents of the database may then be made available to the linked AR tool viewers. The revised database may be stored within the electronic memory of an editing tool computation device, which may then be accessed as needed by various AR tool viewers. Alternatively, the revised database may be proactively distributed or pushed electronically, such as network or wireless signal, to the computation devices of various AR tool viewers, and stored locally on the computation device utilized by each AR tool viewer. In another embodiment, the media containing the revised database may be distributed to each AR tool view, such as on a digital storage medium, such as thumbdrive, flash card, or the like, and loaded into the computation device(s) utilized by each of the AR tool viewers.

Should additional edits be necessary, the editing tool user may further edit the site information as needed, using the edit button and searching or selecting the pre-existing site from the menu. The revised information may then be distributed as discussed above.

In some embodiments, the list of icons and their associated information place holders would include standardized HAZMAT symbols and NFPA 170 icons, as the standardized information would be readily understood within the industry to efficiently convey critical information regarding the site.

In an embodiment, the image displayed on the screen may be modified by the software, or otherwise subjected to video filtering. This may be accomplished by selectively applying one or more effects that could enhance the display for the viewer. For example, video filtering of live video images may be manipulated to enhance low light, flaming light, or flashing light filters that provide the best images possible for the viewer.

The foregoing illustrates some of the possibilities for practicing the invention. Many other embodiments and fields of use for a system for preparing an augmented reality display and hazards and resources database, and the components thereof contributing to the invention are possible and within the scope and spirit of the invention. It is, therefore intended that the foregoing description be regarded as illustrative rather than limiting, and that the scope of the invention is given by the appended claims, together with their full range of equivalents.

What is claimed is:

1. An augmented reality system comprising:
an augmented reality tool editor and an augmented reality tool viewer, the augmented reality tool editor configured to allow editing and entry of volume information for access by the augmented reality tool viewer configured to generate an augmented reality composite image;
wherein the augmented reality tool editor includes:
an editor display device,
electronic memory storage,
a computer accessible database containing volume information identifying fire protection features and fire protection hazards stored in the electronic memory, and
a computational device and editing software configured to allow selective modifications to the volume information; and,
wherein the augmented reality tool viewer includes:
a viewer display device,
a user interface,
a camera,
a computing device and viewing software configured to electronically access the computer accessible database, and create a composite image for viewing on a display, the composite image comprising volume information overlaid upon an image.

2. The augmented reality system of claim 1, wherein the image is one of: perspective view received from the camera, 2D plan view, and representative of a location.

3. The augmented reality system of claim 2, wherein the image is a perspective view received from the camera, and the camera is one of: a body mounted camera, a drone mounted camera, a helmet mounted camera, display capable glasses or goggles, a hand held camera, a tablet camera, and a cell phone camera.

4. The augmented reality system of claim 3, wherein the composite image includes an image received from the camera, and the overlaid volume information provides an indication of the nature of the fire protection features and fire protection hazards located nearby.

5. The augmented reality system of claim 1, wherein the viewer display is a touch screen for use with a finger or stylus and configured to recognize inputs and gestures.

6. The augmented reality system of claim 5, wherein the input and gestures are configured to allow navigation through the user interface.

7. The augmented reality system of claim 4, wherein the composite image provides a location icon in a fixed location on the viewer display when the camera is located within a pre-determined range of a volume location.

8. The augmented reality system of claim 4, wherein the composite image displays an icon representative of all occurrences of the volume information that fall within the composite image.

9. The augmented reality system of claim 8, wherein the icon graphically represents the nature of the volume.

10. The augmented reality system of claim 9, wherein the icon displayed on the composite image varies in a property proportional with the distance from the camera.

11. The augmented reality system of claim 10, wherein the property is selected from the group of size, opacity, and combinations thereof.

12. A method of using an augmented reality system configured to provide a composite augmented reality image comprising volume information and an image, the method comprising:
providing an augmented reality tool editor and an augmented reality tool viewer;
providing an electronically accessible database containing volume information identifying fire protection features and fire protection hazards stored in an electronic memory;
providing image representative of a user perspective;
determining volume information from the electronically accessible database correspondingly located within the image,
overlaying an icon representative of each volume information onto the image to provide a composite augmented reality image; and
providing the composite augmented reality image on a user display.

13. The method of claim 12, wherein the image is one of: perspective view received from the camera, 2D plan view, and representative of a location.

14. The method of claim 13, wherein the image is a perspective view received from the camera, and the camera is one of: a body mounted camera, a drone mounted camera, a helmet mounted camera, display capable glasses or goggles, a hand held camera, a tablet camera, and a cell phone camera.

15. The method of claim 14, wherein the composite image includes an image received from the camera, and the overlaid volume information provides an indication of the nature of the fire protection features and fire protection hazards located nearby.

16. The method of claim 12, wherein the user display is a touch screen for use with a finger or stylus and configured to recognize inputs and gestures.

17. The method of claim 16, wherein the input and gestures are configured to allow navigation through the user interface.

18. The method of claim 15, wherein the composite image provides a location icon in a fixed location on the viewer display when the camera is located within a pre-determined range of a volume location.

19. The method of claim 15, wherein the composite image displays an icon representative of all occurrences of the volume information that fall within the composite image.

20. The method of claim 19, wherein the icon graphically represents the nature of the volume.
